(19) United States
(12) Patent Application Publication
(10) Pub. No.: US 2007/0173960 A1
(43) Pub. Date: Jul. 26, 2007

(54) COMPACT MODULAR PROGRAMMABLE LOGIC CONTROLLER

(76) Inventor: Shalabh Kumar, Kildeer, IL (US)

Correspondence Address: AUTOTECH TECHNOLOGIES, LLP, 4140 UTICA RIDGE ROAD, BETTENDORF, IA, 52722, US

(21) Appl. No.: 11/625,818

(22) Filed: Jan. 22, 2007

Related U.S. Application Data
(60) Provisional application No. 60/766,495, filed on Jan. 23, 2006.

(51) Int. Cl. G05B 13/02

(52) U.S. Cl. 700/40

(57) ABSTRACT

A compact lower cost programmable logic controller with modular I/O is described. SPI bus is used for accessing multi-byte data from I/O modules, while 8 bit data bus is used to access single byte data from I/O modules. Compact I/O modules with use with the PLC are described. The include short circuit proof DC output modules, Relay output with built-in electromagnetic shield, analog modules with laser trimmed resistors, and high speed counter modules.

### CROSS REFERENCE TO RELATED APPLICATIONS

This application is entitled to the benefit of Provisional Patent Application Ser. No. 60/766495 submitted on Jan. 23, 2006.

### FEDERALLY SPONSORED RESEARCH

Not applicable.

### SEQUENCE LISTING OR PROGRAM

Not applicable

### FIELD OF INVENTION

This invention pertains to the field of automation and controls.

### BACKGROUND OF INVENTION

Programmable Logic Controllers (PLCs) are widely used for automation and control. These include industrial automation, factory automation, building automation etc. PLCs are typically programmed by users to implement their desired control functionality. The most popular programming language for PLCs is ladder logic. PLCs typically run a proprietary operating system and execute user programmed logic indefinitely.

A wide variety of PLCs are available in the market. These include very high end, modular, and expensive to low end fixed functionality. Currently available programmable logic controllers (PLC) with modular I/O are expensive and bulky. Inexpensive PLCs typically do not offer modular I/O. This invention describes an inexpensive PLC that is also modular.

### DESCRIPTION OF DRAWINGS

FIG. 1 shows a block diagram of bottom view of motherboard used in programmable logic controller of current invention.

FIG. 2 shows a block diagram of top view of the motherboard.

FIG. 3 shows a block diagram of CPU and its bus as it relates to module connector on the motherboard.

FIG. 4 shows a typical module connector, and its bus signals.

FIG. 5 shows a screen shot of the programming software for the PLC of this invention. The figure illustrate free placement of rung elements.

FIGS. 6A and 6B shows schematics of DC sink and source output respectively.

FIG. 7 shows scheme of short circuit protection.

### DESCRIPTION OF INVENTION

Programmable logic controllers (PLCs) available with modular I/O are expensive. Lower cost PLCs typically have factory-ordered I/O and do not provide modular I/O. This invention describes a low cost, compact PLC with modular I/O. Cost reduction has been possible due to innovative assembly, motherboard and I/O module design. The PLC of this invention is programmed using ladder logic. The PLC stores the user programmed ladder logic and executes the same indefinitely.

### PLC: Motherboard, CPU And Communications

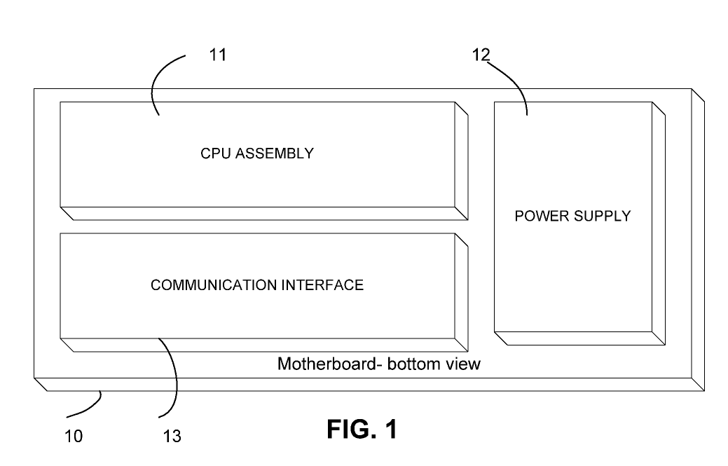

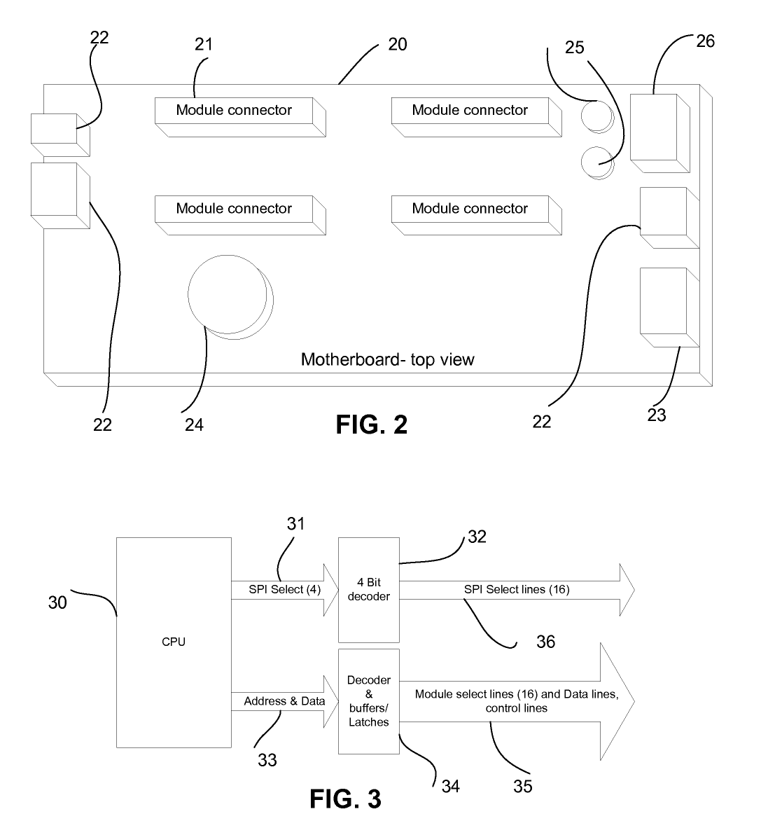

FIG. 1 and FIG. 2 show block diagrams of bottom and top views of motherboard used in this invention. The motherboard 10 in this case is an active motherboard with power supply 12 built on the bottom side of the motherboard. CPU board 11 is also soldered on the motherboard 10. CPU assembly is the brain of the PLC. It includes a microcontroller (a Motorola Coldfire chip), FLASH memory for firmware, RAM, communication ports (Ethernet and serial communications), and other supporting electronics. The CPU assembly connects to the motherboard using 72 pins. These pins are used to exchange address, data bus and many other signals between the CPU assembly and the motherboard. The motherboard is snaps into an enclosure.

An optional communication interface 13 can also be plugged-in on the bottom side of the motherboard. Optional communication interfaces are provided for popular industrial networks such as DeviceNet, Profibus, etc. With all the necessary fixed electronics on the bottom side, the top side of the motherboard is all available for I/O modules. Motherboard has a 40 pin header for plugging-in the communication interface card.

FIG. 2 shows the top view 20 of the motherboard. In this example, a motherboard with only four module connectors 21 is shown. However larger size motherboards with up to 12 connectors for modules have been built with the same concept. The top side of the motherboard 20 also has several communication connectors 22, and power connector 23. Items 25 shows surface mount LEDs to indicated CPU and power status. Surface mount DIP Switches 26 are used to select between CPU Run and Edit modes. The DIP switches are read by the CPU and based on the DIP switch settings, the CPU enters RUN or Edit mode. The motherboard also has all the necessary electronics to decode address lines from CPU assembly to uniquely address each module connector, and to buffer and/or latch the data. All signals from I/O module connectors pass to the CPU assembly through the motherboard. All signals from communication interface to the CPU assembly module also pass through the motherboard.

The compact PLC supports a variety of I/O module. It supports 8 point discrete input, output, and input/output (combined) modules. These discrete modules are accessed through a parallel 8-bit data bus.

The bus going to I/O module connectors is innovative in that it utilizes SPI bus in addition to the usual parallel data bus. This allows controller to read/write discrete modules using the parallel data bus, while use the SPI bus for multi-byte data access from modules with more than one byte of information. SPI bus allows inexpensive I/O modules for several types of I/O such as Analog input and output, and high speed counter modules.

FIG. 3 shows a CPU 30, and bus from the perspective of I/O modules. The CPU used in the invention (Motorola coldfire) has 4 built-in SPI select lines which can be decoded to provide 16 individual select lines. In this invention, with largest motherboard (12 modules) first four module connectors support two SPI channels, while next 6 support only one channel, and next two support no SPI.

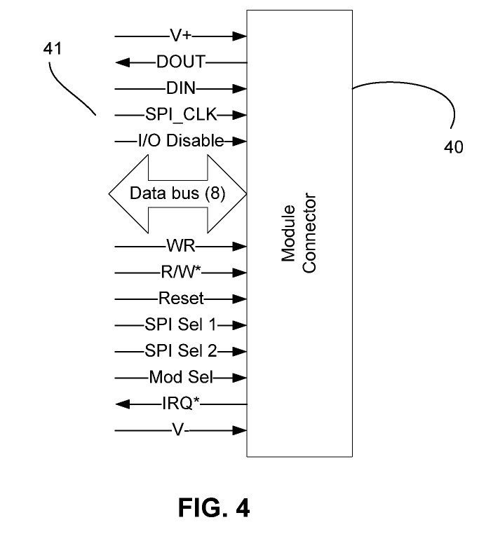

FIG. 4 shows the bus signals going to a typical I/O module. Module connector 40 in this example is a 24 pin dual in line connector with twenty one total signals 21, and three pins reserved for future use.

### PLC: Programming

PLC of this invention is programmed using Windows-based programming software. The programming is done using ladder logic. Ladder logic supports subroutines and interrupt logic. Subroutines are used for organizing logic and for reusing the logic at several places in the ladder logic. The interrupt logic capabilities are provided to execute ladder logic within the interrupt routine immediately in response to some external event.

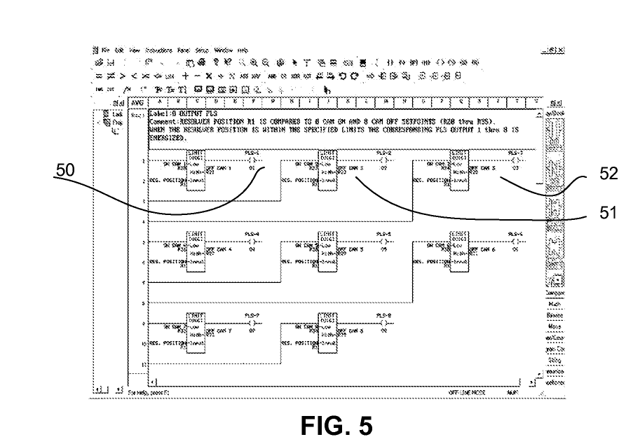

One of the unique features of the programming software is that it allows flexibility in rung element placement within a rung. FIG. 5 an example of the same. We call it free flow. As shown elements 51 and 52 are placed in the same row as the elements 50. This saves vertical space, allowing users to display more elements on screen. It reduces number of rungs and scan time.

### PLC I/O Modules

The compact PLC of this invention supports a variety of I/O modules. These include discrete input, discrete output, discrete input & output, analog input, analog output, analog input & output, high speed counter, Thermocouple input, and RTD input modules. All modules are very compact in size measuring less than 2″ in length and width, and about 1.2″ in height. All modules have a removable 11-position screw-terminal type of connector. All discrete modules have optically isolated I/O. Discrete modules are accessed byte-wide (8 bits) data bus. Other modules, such as analog, are accessed using SPI bus.

### Discrete I/O Modules

The discrete input modules support 8 inputs and are available in DC input, AC input, or DC high speed input models. Input module with interrupt capability is also offered. Whenever input with interrupt capabilities is active, the PLC executes logic programmed in the interrupt routine of ladder logic.

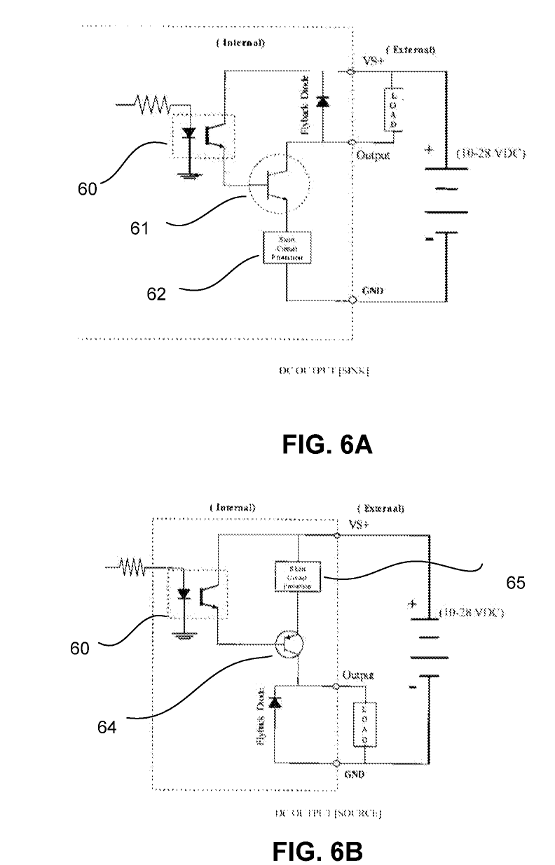

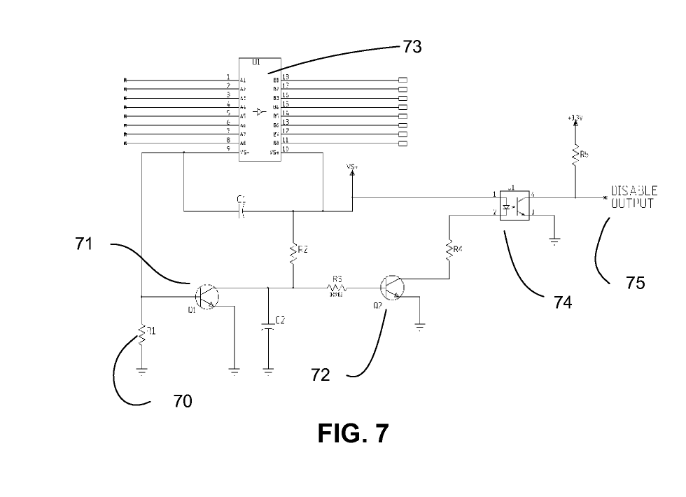

Discrete output modules are available as 8 point DC output sourcing, 8 point DC output sinking, 8 point AC output, or 4 point relay output modules. The DC output modules (sinking and sourcing both) have the feature of short circuit protection. FIGS. 6A and 6B shows schematics for a typical DC output sinking and DC output sourcing output, respectively. As shown the outputs are optically isolated 60. The module is short circuit protected. Short circuit protection 62, 65 are placed in the emitter side of switching transistors 61, 64. FIG. 7 shows short circuit protection scheme in more detail. The figure shows the schematic for a sinking output module. The sourcing module uses a similar scheme. As shown, a current sense resistor 70 is placed between the common of the output driver chip 73, and power supply common. Total output current then flows through this current sense resistor. If the voltage drop across current sense resistor 70 exceeds conduction voltage of transistor 71, the transistor conducts, and forces transistor 72 off. This disable output 75 to change state (become high). This output then is used to disable the outputs to the driver chip, essentially turning off the outputs. Optical isolator 74 provides isolation between the field signals and internal signals.

The relay output module uses reed-relays with built-in electro magnetic (EM) shield to minimize radiation. Reduced EM radiations allow compact size of the controller without worrying about the radiated noise interference.

AC output modules consume very low current.

Several combination I/O modules are available, which offers both inputs and outputs of different types, or inputs of different types, or outputs of different types, providing great flexibility to users. Some of the combination modules are: 4 DC inputs/4 DC Output sinking; 4 DC inputs/4 DC fast inputs with interrupt; 4 DC inputs/4 DC source output; 4 AC inputs/4 AC outputs; 4 DC output source/4 AC output; 4 AC Input/4 DC output; 4 DC input/4 AC output; 4 AC input/4 relay output; 4 DC input/4 relay output.

### I/O Modules with SPI

Modules requiring more than one byte of information are accessed using SPI. These include Analog, Thermocouple, RTD and high speed counter modules.

Analog modules are available for voltage and current, with 8 inputs or 8 outputs. Mixed analog modules are also available 4 inputs and 4 outputs available on the same module. Analog modules utilize precision laser trimmed resistors for achieving desired precision and accuracy.

The compact PLC offers module for 4 thermocouple inputs, and a module for 4 RTD inputs for temperature measurements.

The compact PLC offer two high speed 24 bit counter modules with programmable limit switch (PLS) outputs. The counter module has its own microcontroller, providing high speed counting and PLS outputs. Counter modules provide a flexible counter within compact size with SPI connectivity to the motherboard. The module provides several counter modes. These include: quadrature, quadrature×2, quadrature×4. A programmable logic device decodes quadrature modes and provides count pulses and direction signal to the microcomputer on the module for counting and for PLS operation.

What is claimed is:

1. A compact modular programmable controller having memory means to store user program, having input means to read the status of field devices connected to said means, having output means to control the operation of field devices connected to said means, having microprocessor means with an operating system to control the operation of processor means, having power supply means to provide DC voltages to various solid state devices in said controller, having an active motherboard that contains said power supply means; said microprocessor means; said memory means; decoder means to interface said microprocessor to input and output means; and plug-in connectors to attach variety of input and output modules.

2. A compact modular programmable controller of claim 1 wherein said decoder means include Serial Protocol Interface bus.

3. A compact modular programmable controller of claim 1 wherein said user program is written in ladder logic.

4. A compact modular programmable controller of claim 1 wherein said user program is stored in a non-volatile memory.

5. A compact modular programmable controller of claim 1 wherein said input and output modules contain printed circuit boards mounted parallel to said motherboard.

6. A compact modular programmable controller of claim 1 wherein said operating system is a non-windows based software.

7. A compact modular programmable controller of claim 1 wherein said active motherboard has a snap-in fit into an enclosure that houses said controller.

8. A compact modular programmable controller of claim 1 wherein said motherboard has surface mount LEDs to indicate the status of controller modes of operation.

9. A compact modular programmable controller of claim 8 wherein a surface mount switch selects controller operating modes.

10. A compact modular programmable controller of claim 1 wherein a plug-in output module has means to turn on or off multiple electronic switches in said module wherein said switches contain single current sensing means that turn off said switches in case of current overload through any one or more of said switches.

11. A plug-in Input/Output module used in a programmable controller wherein the means to transmit electrical signals from the processor contained in said controller, include Serial Protocol Interface bus.

12. A plug-in input/output module to be used in a programmable controller, having means to turn on or off multiple electronic switches in said module wherein said switches comprise of compact electromechanical relays having electromagnetic shields inside each relay.

13. A plug-in analog input or output module, to be used in a programmable controller, wherein the means to transmit analog electrical signals from the processor contained in said controller, include at least one laser trimmed thick film resistor network.

14. An intelligent plug-in input/output module to be used in a programmable controller having microprocessor means and comparison means to count pulses from a field device connected to the module, wherein said microprocessor and comparison means are built inside a solid state device to increase counting and comparison speed, and said device contains Serial Protocol Interface bus.
